(19) United States
(12) Patent Application Publication
(10) Pub. No.: US 2014/0036888 A1
(43) Pub. Date: Feb. 6, 2014

(54) METHOD FOR EFFICIENT MU-MIMO TRANSMISSION VIA BLIND INTERFERENCE ALIGNMENT SCHEMES WITH REDUCED CHANNEL COHERENCE-TIME REQUIREMENTS

(71) Applicant: Haralabos C. Papadopoulos, San Jose, CA (US)

(72) Inventor: Haralabos C. Papadopoulos, San Jose, CA (US)

(21) Appl. No.: 14/110,700

(22) PCT Filed: Apr. 26, 2012
(86) PCT No.: PCT/US12/35293

§ 371 Date: Oct. 8, 2013

Related U.S. Application Data
(60) Provisional application No. 61/479,782, filed on Apr. 27, 2011.

(51) Int. Cl. H04B 7/04; H04L 5/00

(52) U.S. Cl. CPC H04B 7/0452; H04L 5/0073
USPC 370/336

(57) ABSTRACT

A wireless communication system, method and base station for using a multi-user MIMO (MU-MIMO)-based blind interference alignment (BIA) scheme are described. In one embodiment, the wireless communication system comprises a plurality of terminals, wherein each terminal in the plurality has a single radio frequency (RF) chain that is operable in M antenna modes, where M is an integer, and further wherein each terminal shifts between the M antenna modes in a predetermined manner. The wireless communication system also includes one or more base stations to perform downlink transmissions to the plurality of terminals using a transmitter array of M transmit antennas and operable to communicate with one or more of the terminals using a multi-user MIMO (MU-MIMO)-based blind interference alignment (BIA) scheme that uses at least one code BIA code serving K terminals from the transmitter array over L(M+K−1) slots for some L>0, wherein at least one of the one or more base stations transmits L symbols for user k, and where the L symbols for user k are transmitted over M distinct slots, within a set of L(M+D−1) consecutive slots, and where D is an integer less than K.

### PRIORITY

The present patent application claims priority to and incorporates by reference the corresponding provisional patent application Ser. No. 61/479,782, titled, “A Method for Efficient MU-MIMO Transmission via Blind Interference Alignment Schemes with Reduced Channel Coherence-Time Requirements,” filed on Apr. 27, 2011.

### FIELD OF THE INVENTION

Embodiments of the present invention relate to the field of multi-user Multiple Output Multiple Input (MIMO) wireless transmission systems; more particularly, the present invention relates to Blind Interference Alignment (BIA) techniques that can be used to support Multi-User MIMO transmission.

### BACKGROUND OF THE INVENTION

Many recent advances in wireless transmission have rested on the use of multiple antennas for transmission and reception. Multiple antennas, fundamentally, can provide an increase in the numbers of Degrees of Freedom (DoFs) that can be exploited by a wireless system for transmission, i.e., the number of scalar data streams that can be simultaneously transmitted to the receiving parties in the system. Here, DoFs can be used to provide increased spectral efficiency (throughput) and/or added diversity (robustness). Indeed, a Single User MIMO (SU-MIMO) system with Nₜ transmission (TX) antennas serving a single user with Nᵣ receive (RX) antennas may be able to exploit up to min(Nₜ, Nᵣ) DoFs for downlink transmission. These DOFs, for example, can under certain conditions be used to improve throughput by a factor that grows linearly with min(Nₜ, Nᵣ). Such benefits of MIMO, and increased DoFs, underlie much of the interest in using MIMO in new and future systems.

Exploiting such DoFs often requires some amount of cost to the system. One such cost is knowledge of the channel state between transmitting and receiving antennas. Such Channel State Information (CSI) often has to be available to either the transmitter (such CSI is termed CSIT) and/or to the receiver (such CSI is termed CSIR).

The DoFs available also depend on having sufficient “richness” in the channels between transmitting and receiving antennas. For example, SU-MIMO CSIR-based systems such as Bit Interleaved Coded Modulation (BICM) and D-BLAST can achieve the maximum possible DoFs of min(Nₜ, Nᵣ) under suitable channel conditions. CSIT is not required. Under such conditions, they therefore can be used to provide corresponding linear increases in spectral efficiency. Such designs are well understood by those familiar with the state of the art.

Similarly, a Multi-User MIMO (MU-MIMO) system with Nₜ transmission antennas at the base station (BS) and K single-antenna users (Nᵣ=1) can provide up to min(Nₜ,K) DoFs. As in the case of SU-MIMO, MU-MIMO can, for example, be used to improve throughput linearly with min(Nₜ,K).

However, unlike SU-MIMO, many MU-MIMO techniques (in fact most if not all of the prevailing MU-MIMO techniques used and studied for standards) require knowledge of CSIT. MU-MIMO based on CSIT, unlike SU-MIMO based on CSIR, requires additional overhead to estimate CSI and feedback CSI to transmitters before the transmission can take place.

Despite such overheads, MU-MIMO is of practical interest since it has the benefit over SU-MIMO of being able to grow the DoFs without having to add many receive antennas, radio frequency (RF) chains, or increase processing (e.g., decoding) complexity to portable or mobile devices.

The issue of CSI overhead has to be considered carefully. It is a fundamental issue often overlooked in assessing such conventional MIMO systems. Such CSI-related overhead in fact can represent a fundamental “dimensionality bottleneck” that can limit the net spectral efficiency increase that can be obtained with conventional CSI-dependent MIMO. In particular, if one wants to continue to exploit the growth in DoFs (e.g., linear growth) by increasing Nₜ (or Nᵣ or K), one also has to consider how to support increased system overhead in obtaining the CSI required to formulate transmissions and decode at the receivers. Such overhead can include increased use of the wireless medium for pilots supporting CSI estimation and increased feedback between receiving and transmitting entities on such CSI estimates.

As an example, assume that for each complex scalar value that defines the CSI between a single TX antenna and a single RX antenna (this type of CSI is often termed “direct CSI” by some in the Standards community), a fixed percentage F_{csi} of wireless-channel resources is dedicated to pilots and/or feedback. It can be shown that as the dimension of the CSI required scales with quantities like Nₜ, Nᵣ and/or K, the total CSI system-related overhead grows (e.g., by Nₜ×F_{csi}). For example, for K single antenna users, each with Nₜ CSI scalar terms with respect to the transmitting antenna, there are a total of KNₜ such complex scalar values that the transmitter may need to know. Supporting an increase in the dimension of the CSI can take more wireless-channel resources and reduces the amount of resources left for data transmission. This overhead increase can limit continued growth in throughput if spectral efficiency improvements do not offset increased CSI overheads.

The value F_{csi} is often defined either by the system or by necessity given the coherence of channels in time and/or frequency. As the state of channels changes more rapidly in time and/or frequency, a larger effective fraction of resources may need to be used to estimate and keep track of CSI.

As an example, in a Frequency Division Duplex (FDD) based 3GPP Long Term Evolution (LTE) design, 8 symbols in a resource block of 12×14 OFDM symbols are used to support downlink pilots for each of the Nₜ antennas. Simply considering system overhead for such pilots, and ignoring other CSI related overheads such as feedback, F_{csi} can be as large as 8/168=4.76%. It means that with Nₜ=8, assuming the pilot structure scales linearly with additional antennas, the total CSI-overhead could be as large as 38%, leaving 62% of symbols for supporting the remaining signaling overhead and data transmission. In fact, LTE has considered to change the pilot structure beyond Nₜ=4 antennas. However, this also has implications to CSI accuracy. Nonetheless, clearly, such a system would not support unbounded increases in Nₜ.

Therefore, though symbols that represent coded data information are used more efficiently, with increased robustness and/or spectral efficiency due to the increased DoFs by MIMO, the net spectral efficiency increases have to account for the fraction of resources used for CSI overhead. Thus, the net spectral efficiency growth is in fact less than that of individual data symbols as only a fraction, e.g. no more than (1−Nₜ×F_{csi}), of symbols can be used for data.

Recently, a new class of techniques, referred to as “Blind Interference Alignment” (BIA) techniques, has demonstrated the ability to grow DoFs without requiring many of the CSI overheads of conventional MU-MIMO systems. In such a system multiple users, each having a few receive antenna elements, are able to simultaneously receive multiple data streams (at least one intended for each user) over the same transmission resource. The BIA techniques allow transmission and alignment of interference between the streams to be done without the transmitter needing to know the instantaneous channel state information (CSI) between transmitter and receiver. In this way, it is possible for a BIA Multi-User MIMO (MU-MIMO) system with Nₜ transmission antennas at the base station and K single active-antenna users to achieve KNₜ/(K+Nₜ−1) DoFs without CSIT. Thus, as K grows, the system can approach the CSI-dependent upper bound of min(Nₜ,K) DoFs that is achievable by conventional MU-MIMO CSIT-based systems. This is a striking result since it goes ahead of much of the conventional thinking and conjectures over recent decades, and it provides the potential to relieve the “dimensionality bottleneck” being faced by current systems.

For a BIA-based system to work, there is a requirement that the channels between the transmitting base station and the K users being served, must be jointly changing in a predetermined way (with respect to the blind interference alignment scheme). This joint variation can be accomplished by having multiple antenna modes. This can be implemented by employing many (physical) antenna elements at each user, or by having a single antenna element that can change its physical characteristic (e.g., orientation, sensitivity pattern, etc.). However, in all such cases, the system requires only that one mode be active at a given time slot. Thus, it is sufficient to have only a single RF chain at each mobile, whereby the single active-receive antenna mode of a user i.e., the antenna driving the single RF chain of the user, can be varied over time. In other words, the single active receive antenna is a multi-mode antenna, able to switch between, e.g., Nₜ modes in a pre-determined fashion. Having a single RF chain keeps decoding complexity in line with conventional single-antenna mode MU-MIMO systems.

The modes must be able to create linearly independent (e.g., linearly independent) CSI vectors for the single user. Transmission also has to be confined to a suitable coherence interval in time over which the CSI in a given mode, though unknown to the system, is assumed to be effectively constant and different from mode to mode.

The BIA technique works by creating a suitable antenna mode switching and combined data transmission vector over the K information bearing streams that are to be sent to the K users (one stream carries the intended information for one user). Such information bearing stream themselves are vectors. These are sent in various arithmetic combinations simultaneously thus using the extra DoFs provided by the antenna mode switching.

The coordination of user receive-antenna switching modes and the way the information streams are sent by the BIA scheme is designed to maximize the DoFs by complying with the following principles:
Any Nₜ dimensional symbol intended for a given user is transmitted through Nₜ slots
During these Nₜ slots, the antenna-switching pattern of that user ensures that the user observes that symbol through all its Nₜ antenna modes (thereby in an Nₜ dimensional space) and can thus decode it.
In contrast, the antenna-switch patterns of the rest of the users are such that the transmission of this Nₜ dimensional symbol only casts a 1-dimensional shadow to their receivers. This is accomplished by ensuring that each of these receivers uses the same antenna mode in all the Nₜ dimensional symbol is transmitted.

Thus, a total of (Nₜ+K−1) receiver dimensions are needed per user to decode Nₜ scalar symbols. As a result, with this scheme, K users decode a total of KNₜ symbols (Nₜ each) per (Nt+K−1) channel uses, thereby achieving the maximum possible BIA DoF of KNₜ/(Nₜ+K−1).

BIA techniques have some inherent challenges and limitations in the scenarios in which they can be used. One such inherent challenge is that BIA schemes need large coherence times in the user channels, i.e., they require the channels to remain constant sufficiently long to enable canceling out interference from other users streams. In particular, the required channel coherence time increases fast with the number of multiplexed users, K, and the number of antenna modes, M, in the system. Shorter coherence times than those required by the BIA scheme mean that some interfering streams won't be able to be canceled, resulting in loss of DoFs. Therefore, BIA schemes are needed with improved channel coherence-time vs. DoFs performance with respect to the original BIA schemes, as they would increase the operating range of BIA techniques over the inherently time-varying wireless channels.

### SUMMARY OF THE INVENTION

A wireless communication system, method and base station for using a multi-user MIMO (MU-MIMO)-based blind interference alignment (BIA) scheme are described. In one embodiment, the wireless communication system comprises a plurality of terminals, wherein each terminal in the plurality has a single radio frequency (RF) chain that is operable in M antenna modes, where M is an integer, and further wherein each terminal shifts between the M antenna modes in a predetermined terminal-specific manner. The wireless communication system also includes one or more base stations to perform downlink transmissions to the plurality of terminals using a transmitter array of M transmit antennas and operable to communicate with one or more of the terminals using a multi-user MIMO (MU-MIMO)-based blind interference alignment (BIA) scheme that uses at least one code BIA code serving K terminals from the transmitter array over L(M+K−1) slots for some L>0, wherein at least one of the one or more base stations transmits L vector symbols for each user k, where the L symbols for user k are transmitted over M distinct slots each, within a set of L(M+D−1) consecutive slots, for some positive integer D less than K.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates the original, prior art, BIA (2,K) transmission scheme.

FIG. 2 illustrates the original, prior art, BIA (2,4) transmission scheme.

FIG. 3 illustrates a reordering of the original BIA (2,4) transmission scheme.

FIG. 4 illustrates a novel BIA (2,4) scheme.

FIG. 5 illustrates a novel BIA (2,K) scheme.

FIG. 6 illustrates a block description of novel BIA (2,K) transmission schemes.

FIG. 7 illustrates the original, prior art, BIA (3,3) transmission scheme.

FIG. 8 illustrates the original, prior art, BIA (3,3) transmission scheme.

FIG. 9 illustrates a novel BIA (3,3) transmission scheme.

FIG. 10 illustrates a novel BIA (3,3) transmission scheme.

FIG. 11 illustrates the original, prior art, BIA (3,4) transmission scheme.

FIG. 12 illustrates a novel BIA (3,4) transmission scheme.

FIG. 13 illustrates a block description of the original BIA (3,K) scheme.

FIG. 14 illustrates a block description of novel BIA (3,K) transmission schemes.

FIG. 15 illustrates a block description of the original, prior art, BIA (M,K) scheme.

FIG. 16 illustrates a block description of novel BIA (M,K) transmission schemes.

FIG. 17 illustrates a novel BIA scheme serving users with multiple multi-mode antennas.

FIG. 18 illustrates one embodiment of a multi-mode antenna receiver.

FIG. 19 is a block diagram of one embodiment of a base station transmitter.

### DETAILED DESCRIPTION OF THE PRESENT INVENTION

Embodiments of the invention include a number of novel BIA transmission schemes. In one embodiment, the BIA schemes enable high DoFs even in the presence of short channel coherence times. In particular, embodiments of the invention put forward a class of BIA schemes that offer reduced channel coherence-time requirements with respect to the original, prior art, schemes set forth in C. Wang, et al, “Aiming Perfectly in the Dark—Blind Interference Alignment through Staggered Antenna Switching”, February 2010, (hereinafter “Wang”) (hereinafter referred to as the “original BIA scheme” or “Wang”) without sacrificing the resulting degrees of freedom provided by the scheme. For example, in the case of M=2 antenna modes and K users, the scheme requires channel coherence over just two consecutive time slots to achieve the maximum DoFs. This is in sharp contrast to the original, prior art scheme, whose channel time-coherence requirements grow with the number of simultaneously served users, K.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

Embodiments of the invention consider new BIA transmission schemes for use with cellular networks. The new BIA schemes have less strict channel coherence time requirements than prior art BIA schemes. The BIA schemes proposed herein can thus prove more robust to time variations in the channels. The schemes can also be used in conjunction with power variations within the alignment structure as presented in U.S. Patent Application Publication No. 2012/0058788, entitled “Method and Apparatus for Communicating with Blind Interference Alignment using Power Allocation and/or Transmission Architecture”, filed Sep. 1, 2011, and U.S. Patent Application Publication No. 2012/0069824, entitled “Method for Efficient MU-MIMO Transmission by Joint Assignments of Transmission Architecture, and Interference Alignment Schemes using Optimized User-Code Assignments and Power Allocation”, filed Sep. 21, 2011, and can be employed with cellular and beyond-cellular transmission such as those described in U.S. Patent Application Publication No. 2012/0058788, entitled “Method and Apparatus for Communicating with Blind Interference Alignment using Power Allocation and/or Transmission Architecture”, filed Sep. 1, 2011, and U.S. Patent Application Publication No. 2012/0069824, entitled “Method for Efficient MU-MIMO Transmission by Joint Assignments of Transmission Architecture, and Interference Alignment Schemes using Optimized User-Code Assignments and Power Allocation”, filed Sep. 21, 2011.

### The Original BIA Scheme

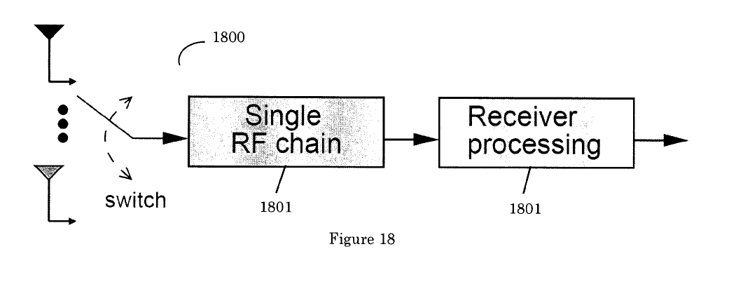

The original BIA scheme well-known by those skilled in the art. For information, see C. Wang, et al, “Aiming Perfectly in the Dark—Blind Interference Alignment through Staggered Antenna Switching”, February 2010, (hereinafter “Wang”) and see Wang et al., “Interference Alignment through Staggered Antenna Switching for MIMO BC with no CSIT”, Proceedings of Asilomar Conference, November 2010. The original BIA scheme describes a method for simultaneously communicating information bearing signals to K receivers from a set of M transmit antennas. Each receiver has M physical antennas or one manipulable antenna (e.g., an antenna who's characteristics are changeable), but only a single RF chain. An example of one such receiver is shown in FIG. 18 where single RF chain 1801 switches between various antenna 1800 and interfaces antennas 1800 with receiver processing 1802. As a result of having only a single RF chain, only one receive antenna (one receive antenna mode) can be active (i.e., can be receiving transmissions) in a given time slot. As a result only one receive antenna can be active (i.e., can be receiving data) in a given slot (e.g., time-frequency slot in an OFDM transmission). For the purposes of exposition, it is assumed that the (average) transmit power per time-frequency slot in the system is “Pₛₗₒₜ”. The BIA(M,K) schemes presented in Wang transmit from a set of M antennas (which, and in particular for the purposes of embodiments of the invention and not necessarily in the original BIA scheme, can reside over one or more BSs) an average of MI(M+K−1) coded symbols to each of K users. This is the maximum for any such alignment scheme (in the absence of CSIT) and it is achieved by
Cycling through the RXAs at each user terminal in a jointly coordinated manner
Systematically transmitting all the user symbols through the M antennas, such that
   Each user can pick out measurements only containing its own symbols (in noise but with no interference from other user symbols).
   At each receiver interfering transmissions are aligned in the minimum possible number of dimensions, and the number of these “wasted” dimensions for such interference alignment is the smallest possible.

Specifically, the scheme transmits to each user a set of M-dimensional vector symbols (or symbol streams). Transmitting a single M-dimensional symbol over the M antennas means that the k-th entry of the vector is transmitted over the k-th antenna, for k=1, 2, . . . , M. A single BIA alignment block in Wang uses a total of “L” slots to deliver to each user k (k=1, 2, . . . , K) a set of “N” vector symbols S₁^{[k]}, S₂^{[k]}, . . . , S_{N}^{[k]}. The values of “N” and “L” are systematically determined in [1] and satisfy,

L=N(M+K−1).

Thus, the average number of symbols provided by the alignment method to each user within the length-L alignment block is given by

$$M \frac{N}{L} = \frac{M}{M + K - 1} .$$

According to Wang, the BIA alignment block of length L comprises of two sub-blocks that are referred to herein as alignment blocks 1 and 2.

Alignment block 1: Block 1 has length N(M−1). In each slot of alignment block 1, the transmitter of the base station (or access point or other wireless transmission device) transmits the sum of K vector symbols, one M-dimensional symbol per user. Which symbol (out of the N symbols) is transmitted for each user is selected in a systematic way to ensure that all symbols are decodable at each user. Examples will illustrate this point.

Alignment block 2: Block 2 has length NK. In each slot of alignment block 2, the transmitter of the base station (or access point or other wireless transmission device transmits only a single M-dimensional symbol. In particular, the transmitter uses N slots in alignment block 2 per user to transmit each of the N user symbols one at a time, and it does so for each of the K users.

In order to ensure that each user can decode its own symbol stream, each user has to cycle through its set of M antenna modes in a predetermined and user-specific manner. In particular, let hₘ^{[k]} denote the 1×M channel vector between the M transmit antennas and the m-th receive antenna mode of the k-th user (where the m-th antenna mode of a user corresponds, for example, to activating the m-th receive antenna for that user). Let also a^{[k]}(t) denote the index of the antenna mode selected by user k in slot t for t=1, 2, . . . , L. Then the following 1×L vector captures the sequence of modes cycled by user k within a given alignment block:

a^{[k]}=[a^{[k]}(1)a^{[k]}(2) . . . a^{[k]}(L)]

Below are provided representative examples of coordinated symbol-user transmissions based on the original BIA scheme presented in Wang. The extensions of these schemes that are of use in embodiments of the invention are presented thereafter.

### Example 1

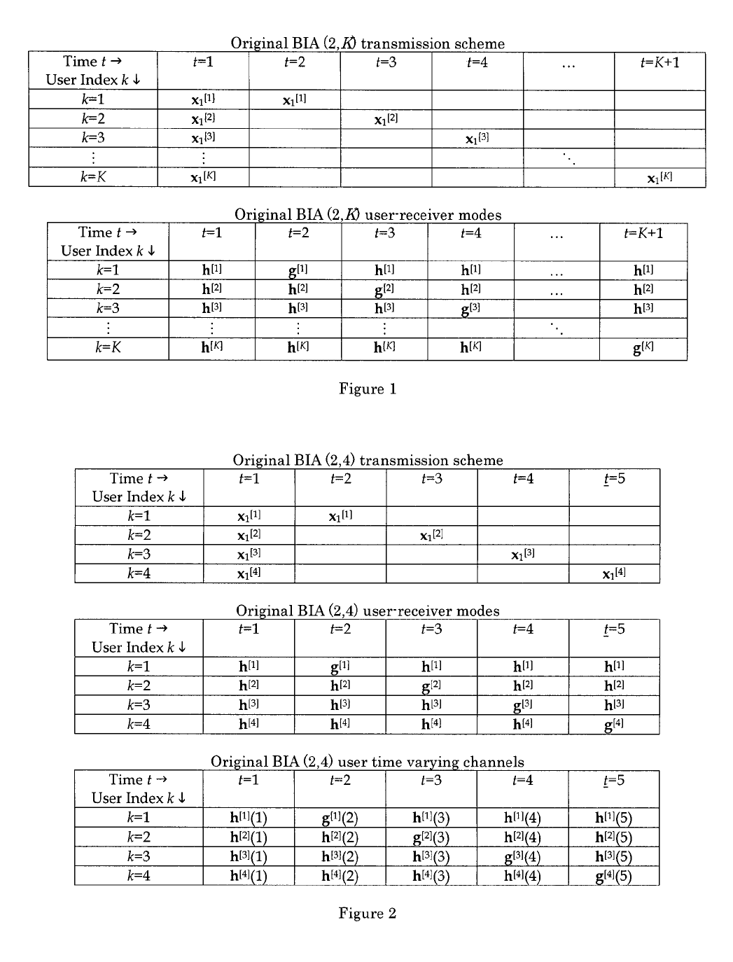

Original BIA scheme in Wang with M=2, arbitrary K. FIG. 1 illustrates the original, prior art, BIA transmission scheme, which, in the case of M=2 transmit antennas (TXAs), and M=2 receive antenna (RXA) modes per receiver, serves simultaneously K users over K+1 transmission slots. The alignment code in this case has length L=K+1 and is shown on the top table in FIG. 1. It delivers to each user a single 2 dimensional symbol, i.e., N=1. In particular, it delivers a 2×1 coded symbol x₁^{[k]} denote to user k. For user k to be able to decode x₁^{[k]}, user k must follow the antenna mode-switching pattern shown on the bottom table of FIG. 1. Letting x(t) denote the transmitted symbol at slot t, the code is as follows:

$$[ x ( 1 ) = {x}_{1}^{[ 1 ]} + {x}_{1}^{[ 2 ]} + L + {x}_{1}^{[ K ]} ] Block 1 \\ [ \begin{matrix}x ( 2 ) = & {x}_{1}^{[ 1 ]} & & & \\ x ( 3 ) = & & {x}_{1}^{[ 2 ]} & & \\ M & & & O & \\ x ( K + 1 ) = & & & & {x}_{1}^{[ K ]}\end{matrix} ] Block 2$$

with user—antenna switching patterns

$${a}^{[ 1 ]} = [ 1 \; 2 \; 1 L ]$$

$${a}^{[ 2 ]} = [ 1 \; 1 \; 2 L ]$$

$$M OO$$

$${a}^{[ K ]} = [ 1 L 1 \; 2 ]$$

Decoding: Consider user k for some k, 1≦k≦K. Because user k uses the same antenna mode in all slots except slot k, subtracting from the received slot−1 signal the sum of the received signals on all slots from slot 2 to slot K+1 and excluding slot k+1, eliminates interference from the symbols of all other users. After interference elimination, receiver k (for k=1, 2, . . . , K) has a measurement signal of the form

$${y}^{[ k ]} = ⌊ \begin{matrix}{h}^{[ k ]} \\ {g}^{[ k ]}\end{matrix} ⌋ {x}_{1}^{[ k ]} + [ \begin{matrix}{z}_{1}^{[ k ]} \\ {z}_{2}^{[ k ]}\end{matrix} ]$$

whereby the zₘ^{[k]} represents noise. Note that in each case, z₁^{[k]} represents the sum of K noise terms. This noise-enhancement effect is again due to the interference cancellation and more pronounced when K is larger, i.e., when more users are served, as the power of z₁^{[k]} is K times as large as z₂^{[k]}. As described in U.S. Patent Application Publication No. 2012/0058788, entitled “Method and Apparatus for Communicating with Blind Interference Alignment using Power Allocation and/or Transmission Architecture”, filed Sep. 1, 2011, the noise enhancement level can be controlled by proper power allocation over the BIA code slots. Such power allocation methods can also be employed in the schemes presented herein. However, for ease of exposition, they are not explicitly described in this application.

The top table in FIG. 1 describes the BIA(2,K) code from Example 1. The bottom table in FIG. 1 describes the user antenna switching patterns, with the implication that mode 1 corresponds to an “h” antenna mode while mode 2 to a “g” antenna mode. However, in practice, channels change over time. As a result, instances over which a user terminal uses the same mode do not in general yield transmission over identical channels. In particular, the strength of the correlation between such channels depends on the coherence time of the channel and their temporal distance (the closer in time they are, the stronger the correlation between the channels).

FIG. 2 illustrates the original BIA transmission scheme from Wang, which, in the case of M=2 transmit antennas, and M=2 receive antenna modes per receiver, simultaneously serves K users over K+1 transmission slots, with K=4. The top two tables in FIG. 2 depict the BIA(2,K) code and the associated antenna switching patterns from Example 1 in the special case K=4. The bottom table in FIG. 2 shows a more detailed description of the channels experienced by the users, accounting for both the antenna-mode switching and the channel variability over time. That is, the bottom table in FIG. 2 relists the antenna-channels associated with the antenna switching patterns of the middle table, while also accounting for the time-variability in the channel. In particular, h^{[k]}(t) and g^{[k]}(t) denote the channels that user terminal k experiences at time t under channel modes 1 and 2, respectively. Note that user k will be able to cancel out interference from the symbol intended for user j (some j different from k), by using the same channel mode on channels at time 1 and j+1, and subtracting its (j+1)^{st} measurement from its 1^{st} measurement. The accuracy of this cancellation depends on how close h^{[k]}(1) is to h^{[k]}(j+1). For j=K, and K=4, this requires user channels 4 samples apart in time to remain sufficiently strongly correlated. In the general K case, this requires user channels up to K samples apart in time to remain sufficiently correlated.

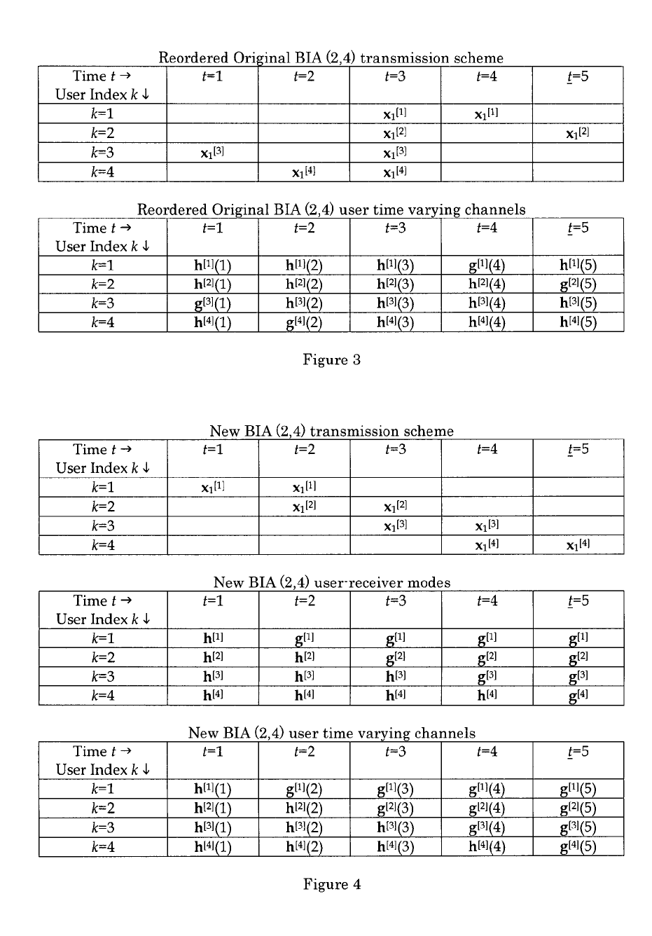

FIG. 3 illustrates a reordering of the original BIA transmission scheme (top) from FIG. 2, which, in the case of M=2 transmit antennas, and M=2 receive antenna modes per receiver, simultaneously serves K users over K+1 transmission slots, with K=4, along with the user-experienced channels associated with the antenna-switching patterns required for interference alignment (bottom). This scheme requires channels to remain sufficiently correlated for 3 (as opposed to 5) time samples. In the general K case, such a reordered scheme would require channel coherence for samples that are K/2 symbols apart in time (for K even), thereby relaxing the coherence-time requirements by a factor of 2. However the coherence-time requirements still grow with K. The bottom table of FIG. 3 shows a detailed description of the channels experienced by the users, accounting for both the antenna-mode switching and the channel variability over time.

Embodiments Involving BIA Schemes with M=2 RXA Modes (and 2 TXAs)

FIG. 4 illustrates a novel BIA scheme, which, in the case of M=2 transmit antennas, and M=2 receive antenna modes per receiver, simultaneously servers K=4 users over K+1=5 transmission slots. The BIA(2,K=4) code structure is as shown by the upper table in FIG. 4. The antenna switching pattern for user k shown in the table in the middle allows user k to cancel out all interference and decode its own symbol. The bottom table shows a detailed description of the channels experienced by the users, accounting for both the antenna-mode switching and the channel variability over time. It can be readily verified that user k can cancel the symbol for user j (some j different from k), by using the same channel mode on channels at time j and j+1, and subtracting its (j+1)^{st} measurement from its j^{th} measurement. The accuracy of this cancellation depends on how close h^{[k]}(j) is to h^{[k]}(j+1). This requires user channels remain sufficiently strongly correlated for two consecutive samples (thereby requiring time coherence over two samples).

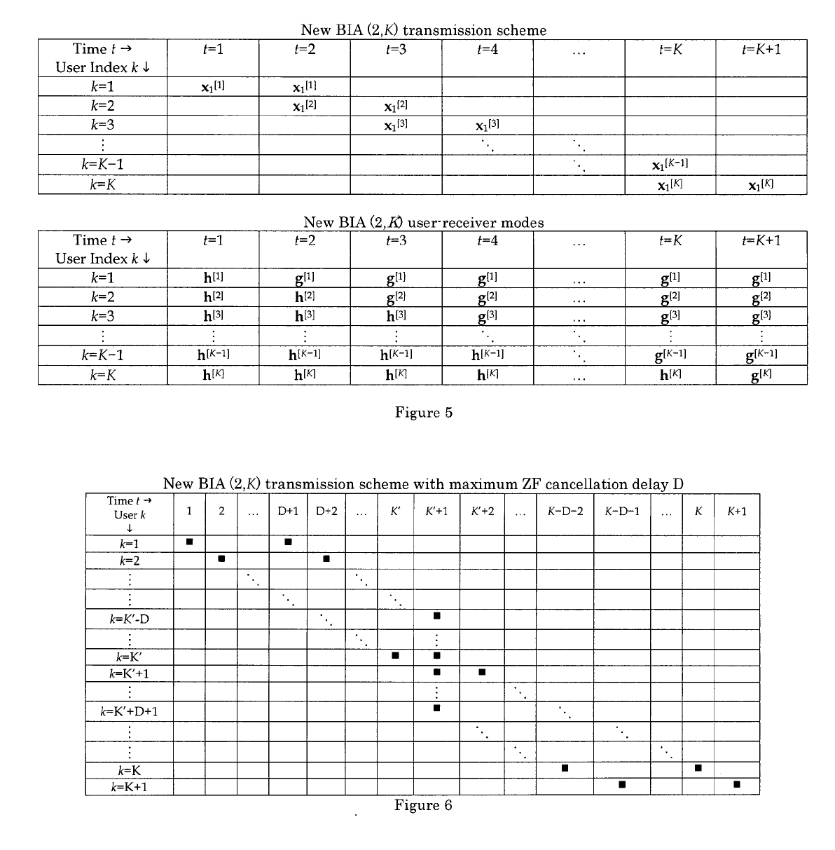

FIG. 5 illustrates the novel BIA scheme, which is an extension of the code structure from FIG. 4 to arbitrary K. In the case of M=2 transmit antennas and M=2 receive antenna modes per receiver, this BIA scheme simultaneously serves K users over K+1 transmission slots. The antenna pattern for user k shown in the table at the bottom of FIG. 5 allows user k to cancel out all interference and decode its own symbol. As is readily evident this scheme requires user channels to remain sufficiently strongly correlated over just two consecutive symbols regardless of the value of K. This enables the channel alignment required to cancel out interference from streams intended for other users.

Other embodiments involve BIA(2,K) code designs, which are tailored to the coherence time of the channel. In particular, FIG. 6 shows an embodiment of a code structure that requires a channel coherence of D samples. A two-dimensional symbol is transmitted to each user. In particular, the two black squares in row k depict transmission of the two dimensional symbol for user terminal k.

In one embodiment, the powers allocated to the transmitted user symbols are varied so that transmission power is constant over time. In one constant-power transmission, the available (constant over time) power is evenly allocated to transmitted symbols in each time slot.

Embodiments Involving BIA Schemes with M RXA Modes (and M TXAs) with M Greater than 2

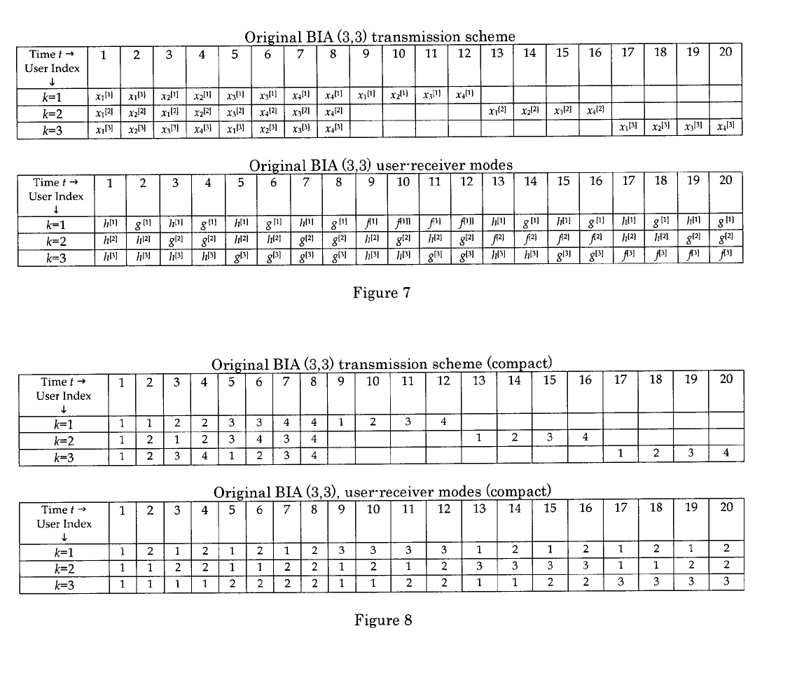

Similar extensions of the original BIA(M,K) schemes can be designed for values of M greater than 2. FIGS. 7-14 describe such extensions for the case of M=3 TX antennas and M=3 antenna modes.

FIGS. 7 and 8 show, respectively, an explicit and compact description of the BIA(3,3) code. FIG. 7 illustrates the original BIA scheme from Wang, which, in the case of M=3 transmit antennas, and M=3 receive antenna modes per receiver, simultaneously serves K=3 users over 20 transmission slots. The antenna pattern for user k shown on the bottom table allows user k to cancel out all interference and decode its own symbols. As shown in the table on the bottom of FIG. 7, when user k chooses modes 1, 2, and 3, the channel between the transmitter and user k is given via the vector h^{[k]} g^{[k]} and f^{[k]}, respectively. FIG. 8 is an alternative, more compact, description of the BIA code and the antenna-mode switching patterns associated with the BIA code shown in FIG. 7. In particular, when the vector symbol xⱼ^{[k]} is part of the transmitted signal in a given time slot n, the symbol “j” is shown on the top table in FIG. 8 in the table entry associated with the row for user k and time slot n, signifying that the j-th symbol for user k is part of the transmitted symbol in time slot n. Note that the code in FIGS. 7 and 8 requires time coherence over slots spaced 16 time samples apart: to cancel, e.g., symbol 1 for user 3 requires the channel to stay constant in time slots 1, 5, and 17.

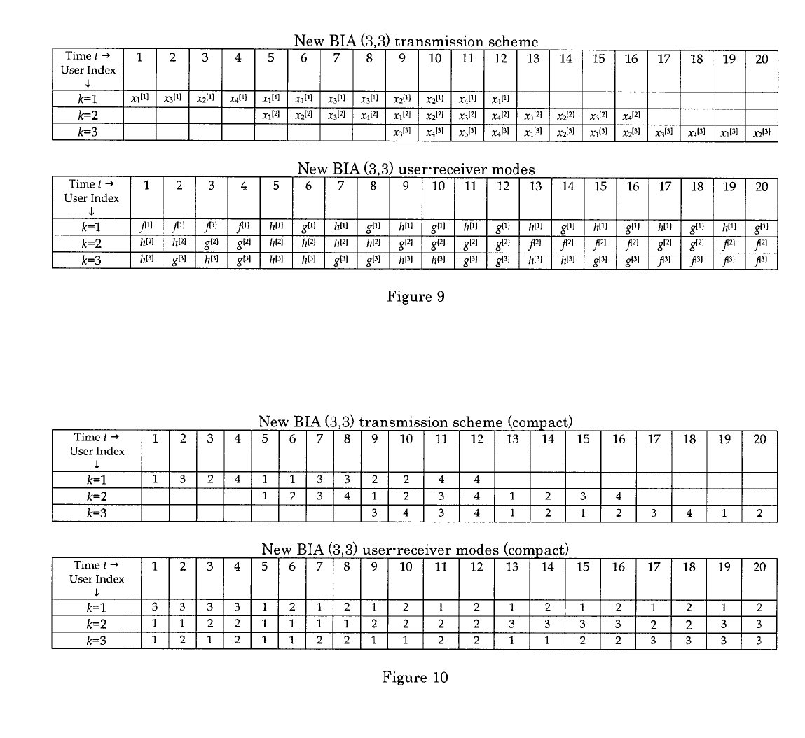

FIGS. 9 and 10 show the associated explicit and compact descriptions of one embodiment of a novel BIA(3,3) code with reduced channel time-coherence requirements. FIG. 9 illustrates a novel BIA transmission scheme, which, in the case of M=3 transmit antennas, and M=3 receive antenna modes per receiver, simultaneously serves K=3 users over 20 transmission slots. The antenna pattern for user k shown on the bottom table allows user k to cancel out all interference and decode its own symbols. Note that, in contrast to the original code in FIGS. 7 and 8, the code in FIGS. 9 and 10 requires time coherence over slots spaced just 8 time samples apart: to cancel, e.g., symbol 4 for user 1 requires the channel to stay constant (at users 2 and 3) in time slots 4, 11, and 12.

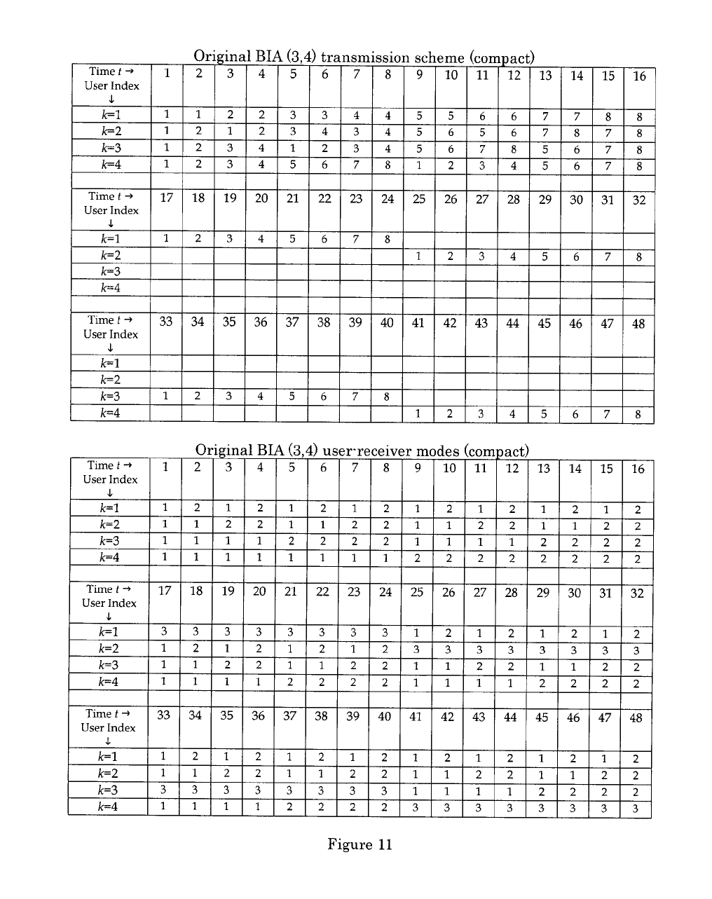

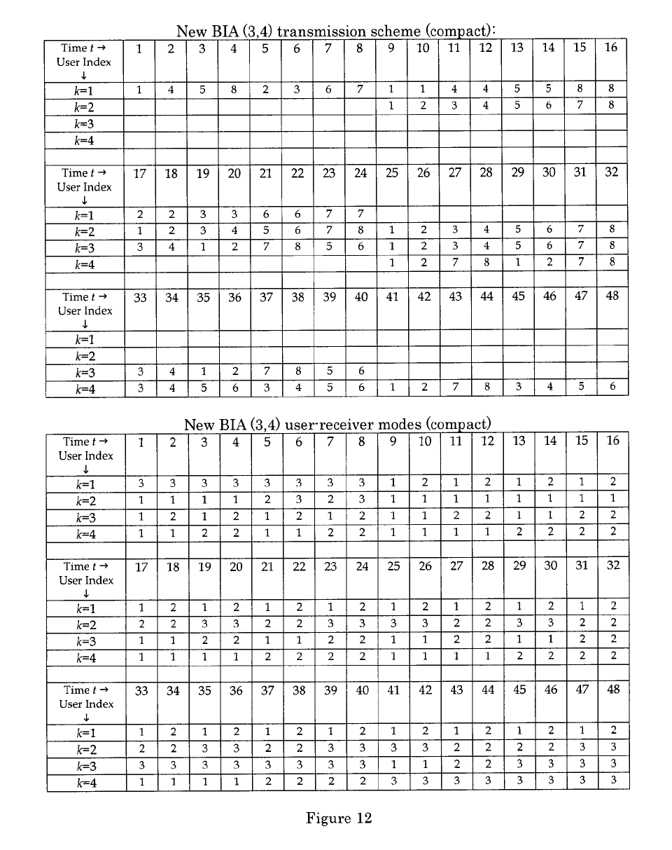

Similarly FIGS. 11 and 12, respectively, show the original BIA(3,4) code and one embodiment of a BIA(3,4) code with reduced channel time-coherence requirements. FIG. 11 illustrates the original BIA scheme in Wang, which, for M=3 TXAs, and M=3 RXA modes per receiver, serves K=4 users over 48 TX slots. FIG. 12 illustrates a novel BIA scheme, which, in the case of M=3 TXAs, and M=3 RXA modes per receiver, serves K=4 users over 48 transmission slots. The code in FIG. 11 requires time coherence over slots spaced 24 time samples apart: to cancel, e.g., symbol 1 for user 3 requires the channel to stay constant (at users 1 and 2) in time slots 1, 9, and 25.

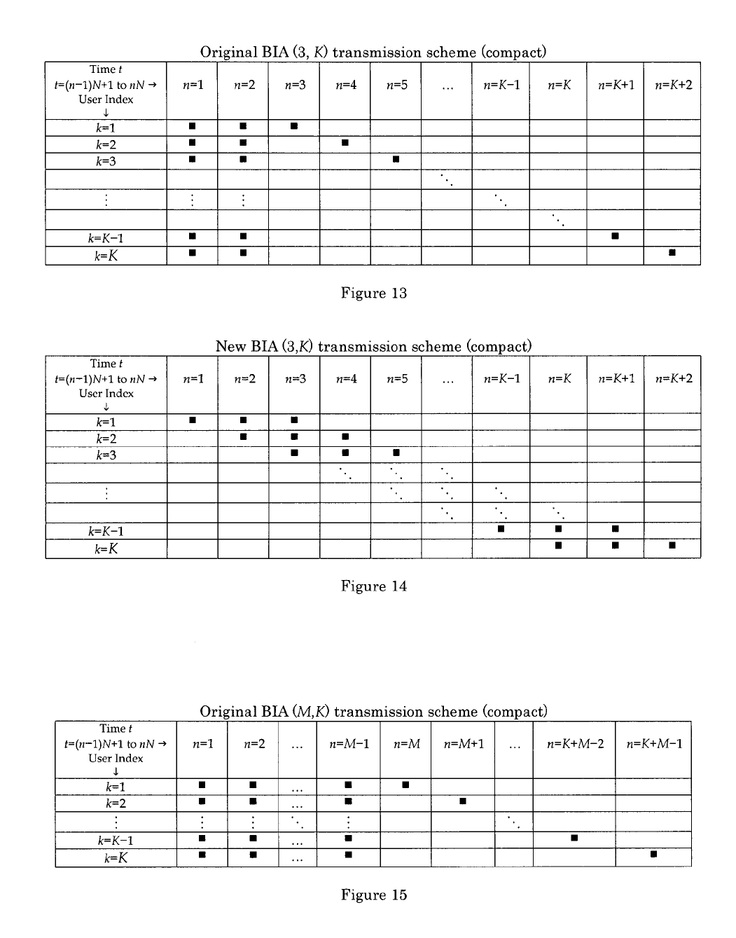

FIGS. 13 and 14 show a logical description of the original BIA(3, K) code and the structure satisfied by certain embodiments of BIA(3,K) codes. As FIG. 14 suggests, unlike the original BIA schemes in Wang, the channel coherence-time requirements of the proposed schemes do not grow with K. FIG. 13 illustrates a block description of the original BIA scheme in Wang, which, in the case of M=3 TXAs, and M=3 RXA modes per receiver, serves K users, sending to each user N 3-dimensional symbols over (K+2)N transmission slots, with N=2^{K-1}. FIG. 14 illustrates a block description of novel BIA transmission schemes, which, in the case of M=3 TXAs, and M=3 RXA modes per receiver, serves K users, over (K+2)N transmission slots. In contrast to the original code in FIG. 11, the code in FIG. 13 requires time coherence over slots spaced just 12 time samples apart: to cancel, e.g., symbol 8 for user 1 requires the channel to stay constant (at users 2 and 3) in time slots 4, 15, and 16.

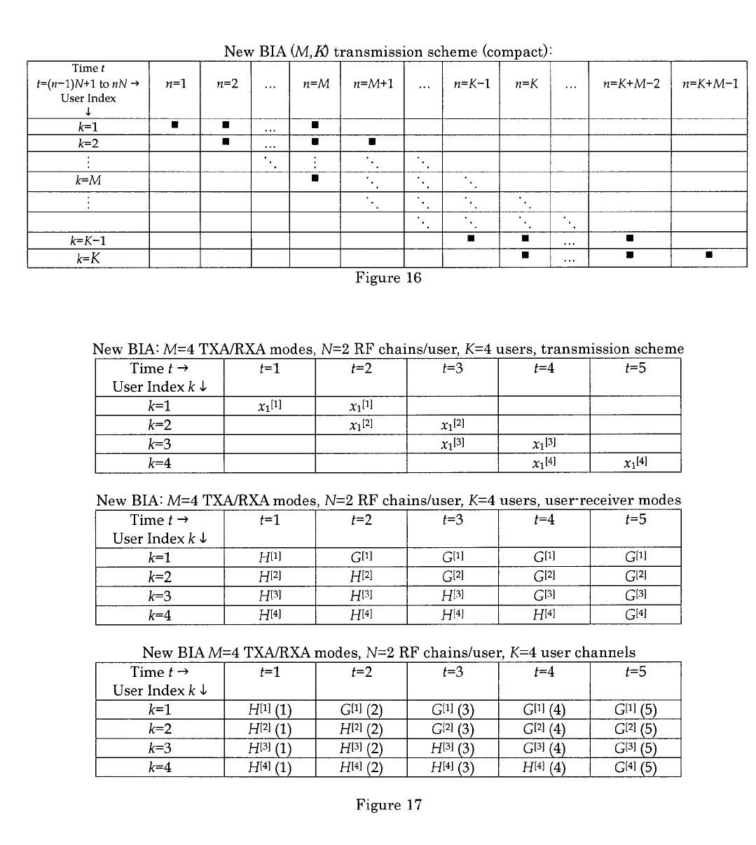

FIGS. 15 and 16 show extensions of these ideas for the arbitrary M, and K cases. FIG. 15 illustrates a block description of the original BIA scheme in Wang, which, in the case of M TXAs, and M RXA modes per receiver, serves K users, sending to each user N M-dimensional symbols over (K+M−1)N transmission slots, with N=(M−1)^{K-1}. FIG. 16 illustrates a block description of novel BIA transmission schemes, which, in the case of M TXAs, and M RXA modes per receiver, serves K users, over (K+M−1)N transmission slots.

Embodiments Involving BIA Schemes with Users with >1 RF Chain and >1 Active RXA Mode at a Time.

Finally, the above code structure can be readily generalized to include transmission to user terminals that have N active RXA modes at any given time (and thus N RF chains), whereby each of the N modes can be one of NM′ preset modes, and where the base stations have (at least) NM′ transmit antennas. In particular, these codes can be inferred from the BIA(M′, K) codes associated with single-active mode terminals. FIG. 17 shows a sample embodiment, involving a BIA coding structure for simultaneously serving K=4 users over K+1=5 transmission slots, each with N=2 simultaneously active antennas (both active at any given time), each antenna being able to switch between a common set of M=4 (single-antenna) receiving modes per receiver and base stations with at least four transmit antennas. The antenna pattern for user k shown in the table in the middle allows user k to cancel out all interference and decode its own symbol. The bottom table shows a detailed description of the channels experienced by the users, accounting for both the antenna-mode switching and the channel variability over time. Close inspection reveals that this BIA code is a direct generalization of the BIA(2,4) code of FIG. 4. In the embodiment shown in FIG. 17, two out of the four modes are reserved for mode switching for each active antenna. As a result in this scheme each user terminal can switch its two-antenna set between an “H”-mode set and a “G”-mode set.

### One Embodiment of a Base Station

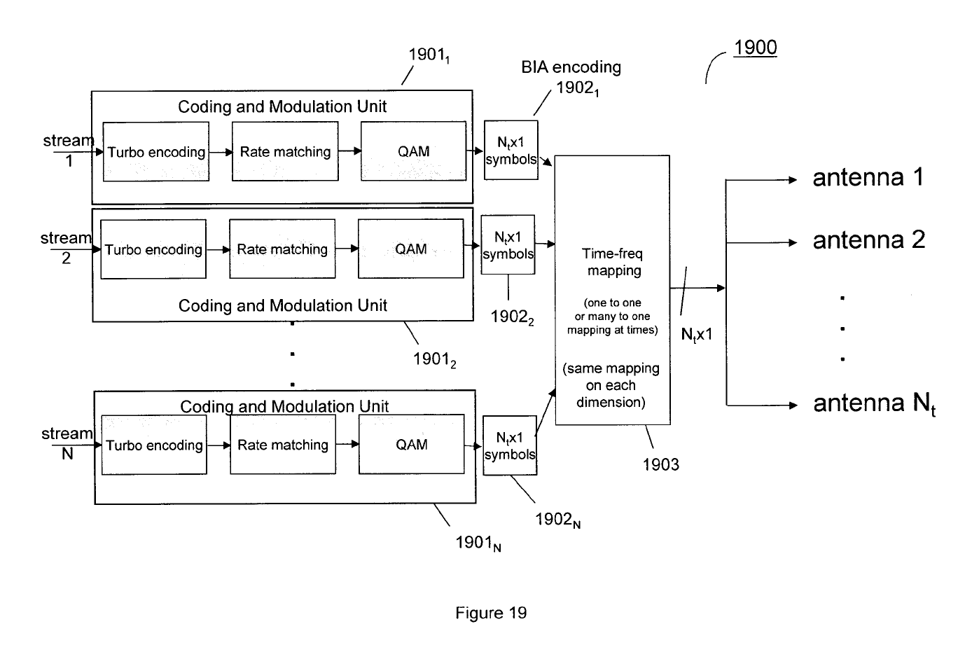

FIG. 19 is a block diagram of one embodiment a base station. Referring to FIG. 19, base station 1900 receives user streams 1-3. While only three streams are shown, one skilled in the art would recognize that less than or more than three streams may be received and their data transmitted. In one embodiment, the user streams are generated locally. In another embodiment, the user streams are provided by a controller. Each of the user streams 1-3 are coded using coding and modulation units 1901_{1-N}, which code each user stream received by the base station. In one embodiment, coding and modulation units 1901_{1-N} includes a turbo encoding unit that performs turbo encoding on the user stream and then provides the encoded data to a rate matching unit. The rate matching unit performs rate matching and outputs data to a QAM modulation unit. The QAM modulation unit may perform 64 QAM, 16 QAM, or some other QAM modulation. Different base stations can use the same coding and modulation to generate the transmission signals that they simultaneously transmit for a given user. However, different base stations can use different coding to create the coded user streams that are input into the base station. For example, one base station may use 64 QAM, while another base station uses 16 QAM to generate coded streams for a particular user. Thus, the code structure of the user streams may be different but the BIA encoding performed by both base stations is the same.

The output of each of the coding and modulation units 1901_{1-N} is input to BIA encoding block 1902_{1-N} which performs BIA encoding, such as the BIA encoding discussed above, for each user using a separate code. The outputs of each of the BIA encoders 1902_{1-N} are input to combiner/mapper 1903, which combines the symbols streams output from BIA encoders 1902_{1-N}, maps them to OFDM slots and transmits them via an OFDM transmitter. The OFDM transmitter wirelessly transmits the data on antennas 1−Nₜ.

Thus, using at least one of the BIA codes described above to serve K terminals, a wireless communication system enables communication between multiple terminals (e.g., receivers) and one or more base stations, wherein each terminal has a single radio frequency (RF) chain that is operable in at least M antenna modes, where M is an integer, and further wherein each terminal shifts between the M antenna modes in a predetermined manner. Each terminal may have a reconfigurable antenna with at least M modes. The one or more base stations perform downlink transmissions to the terminals using a transmitter array of M transmit antennas and are operable to communicate with one or more of the terminals using a multi-user MIMO (MU-MIMO)-based blind interference alignment (BIA) scheme that uses at least one code BIA code serving K terminals from the transmitter array over L(M+K−1) slots for some L>0, wherein at least one of the one or more base stations transmits L symbols for each user k, and whereby the L symbols for user k are transmitted over M distinct slots each within a set of L(M+D−1) consecutive slots for some integer D less than K. Note that the transmitter array may be one base station with M-transmit antennas or a collection of base stations with at least M transmit antennas.

In one embodiment, each of the L symbols is R-dimensional, where R is a positive integer. In such a case, the BIA code sends L R-dimensional symbols (from the M transmit antennas) for each user. In one embodiment, L is equal to M−1^{(K-1)} and R equals M. In one embodiment, M equals 2 and L equals 1 such as in the case of the BIA(2,4) code. In another embodiment, L equals 4 and M equals 3, such as in the case of BIA(3,3) code, such that 4 symbols are placed for each user 3 times each over 12 (ML) consecutive slots from (k−1)4+1 to (k−1)4+12. In yet another embodiment, L equals 8 and M equals 3, such as in the case of the BIA(3,4) code, such that, for each user, 8 symbols are placed 3 times each over 24 (ML) consecutive slots, from (k−1)4+1 to (k−1)4+24. In a further embodiment, in a BIA(M=3,K), for each user L symbols are placed over 3 L consecutive slots, from (k−1)L+1 to (k−1)L+3 L. Notice that each square symbol in FIG. 14 is L slots long. In this case, in one embodiment, L=2^{(K-1)} symbols per user. For each user, these 2^{(K-1)} symbols are placed 3 times each over 3×2^{(K-1)} consecutive slots. Also, for the BIA(M=3,K), for each user, L symbols are placed over ML consecutive slots, from (k−1)L+1 to (k−1)L+ML. Notice that each square symbol in FIG. 16 is L slots long. In this case, in one embodiment, L=(M−1)̂(K−1) symbols per user. For each user, these (M−1)^{(K-1)} symbols are placed M times each over M×(M−1)̂(K−1) consecutive slots.

In one embodiment, the L symbols are transmitted M times each in ML slots from slot (k−1)L+1 to slot (k−1)L+ML.

In one embodiment, the BIA scheme uses at least one code BIA code for serving K users over K+1 transmission slots, with a predetermined delay parameter D, each user terminal capable of switching between (at least) 2 antenna modes,

wherein if K is even and equals 2K′ for an integer K′, then for the given D, satisfying 0<D<K′:

for users with index k between 1 and K′, the symbol for user k is placed in slots k and min(K′+1, k−D+1);

for users with index k greater than K′, the symbol for user k is placed in slots k+1 and max(K′, k−D+1);

wherein if K is odd and equals 1+2K′ for the integer K′, then for a given D, satisfying 0<D<K′:

for users with index k between 1 and K′, the symbol for user k is placed in slots k and min(k+D, K′+1);

for users with index k greater than K′+1, the symbol for user k is placed at slots k+1 and max(k^{t}+2, k−D+1);

for the user with index k equal to K′+1, the symbol for user k is placed at slots K′+1 and K′+2.

In one embodiment, each of the terminals is operable in two antenna modes, and in accordance with the at least one BIA code, the one or more base stations transmits each user's symbol to be transmitted over two consecutive slots. In one embodiment, each of the terminals is operable in two antenna modes, and in accordance with the at least one BIA code, the one or more base stations transmits a sum of 2 symbol streams of 2 different users during each of the k+1 transmission slots except during the first and last of the k+1 transmission slots during which only 1 symbol stream for one of the k users is transmitted, and wherein each user's symbol is transmitted over two consecutive slots.

In one embodiment, the value of D is any positive integer at most as large as K/2. In another embodiment, the value of D is any positive integer less than K/2. More specifically, in the blind interference cancellation schemes described herein, linear combinations of signals received on different slots at a given terminal are used to eliminate interference from each other symbol intended for another user. Take any given symbol, e.g., symbol 1 for user 1. This symbol is transmitted M times (as many as there are modes). To cancel interference from this symbol at any other user, that user has to see this symbol through the same mode and the channel at that mode has to stay sufficiently constant so cancelation of interference caused by that would be possible. To enable cancelation of this symbol at user k (k>1), the coherence time (in slots) of the channel of user k needs to be at least as large as the time difference between the first and the last transmission of symbol 1 of user 1. User k would need to cancel interference from all other symbols from user 1 (i.e., all L symbols for user 1) and all L symbols from all other users (except its own). Thus, if the coherence time is larger than the maximum of these time differences decoding is possible. The quantity (M−1+D) captures this maximum in multiples of L.

Letting dⱼ^{{[k]}} denote the time difference between the first and last occurrence of the j-th symbol of user k and dₘₐₓ=max_{{j,k}} dⱼ^{{[k]}}. Then D is the smallest integer such that L(M−1+D)>=(dₘₐₓ+1)]. This means that, for any given symbol for any given user, all M occurrences of the symbol in the BIA code are within a set of L(M−1+D) consecutive slots.

It should be evident to the person skilled in the arts that embodiments of this invention that consider power allocation extensions of the presented embodiments, analogous to those presented for the original BIA schemes in U.S. Patent Application Publication No. 2012/0058788, entitled “Method and Apparatus for Communicating with Blind Interference Alignment using Power Allocation and/or Transmission Architecture”, filed Sep. 1, 2011, can be readily designed. Also, the techniques described in U.S. Patent Application Publication No. 2012/0069824, entitled “Method for Efficient MU-MIMO Transmission by Joint Assignments of Transmission Architecture, and Interference Alignment Schemes using Optimized User-Code Assignments and Power Allocation”, filed Sep. 21, 2011, may also be used in conjunction with those described herein.

For example, in one embodiment, each of the M distinct transmissions corresponding to each of the L symbols for user k have a different power level. In another embodiment, the power level per slot is constant and shared among symbols transmitted in a slot.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

1. A wireless communication system comprising:
a plurality of terminals, wherein each terminal in the plurality has a single radio frequency (RF) chain that is operable in at least M antenna modes, where M is an integer, and further wherein each terminal is operable to switch among the M antenna modes in a predetermined manner; and
one or more base stations to perform downlink transmissions to the plurality of terminals using a transmitter array of M transmit antennas and being operable to communicate with one or more of the terminals using a multi-user MIMO (MU-MIMO)-based blind interference alignment (BIA) scheme that uses at least one code BIA code serving K terminals from the transmitter array over L(M+K−1) slots for some L>0, wherein at least one of the one or more base stations transmits L symbols to each user terminal k, and where the L symbols for any given terminal are transmitted in M distinct slots each over L(M+D−1) consecutive slots for some integer D smaller than K.

2. The system defined in claim 1 wherein each of the L symbols is R-dimensional, where R is a positive integer, and wherein L is equal to M−1^{(K-1)} and R equals M.

3. The system defined in claim 1 wherein the L symbols are transmitted M times each in ML slots from slot (k−1)L+1 to slot (k−1)L+ML.

4. The system defined in claim 1 wherein the BIA scheme uses at least one code BIA code for serving K users over K+1 transmission slots, with a predetermined delay parameter D, each user terminal being operable in two antenna modes,
wherein if K is even and equals 2K′ for an integer K′, then for the given D, satisfying 0<D<K′:
for users with index k between 1 and K′, the symbol for user k is placed in slots k and min(K′+1, k−D+1);
for users with index k greater than K′, the symbol for user k is placed in slots k+1 and max(K′, k−D+1);
wherein if K is odd and equals 1+2K′ for the integer K′, then for a given D, satisfying 0<D<K′:
for users with index k between 1 and K′, the symbol for user k is placed in slots k and min(k+D, K′+1);
for users with index k greater than K′+1, the symbol for user k is placed at slots k+1 and max(k^{t}+2, k−D+1);
for the user with index k equal to K′+1, the symbol for user k is placed at slots K′+1 and K′+2.

5. The wireless communication system defined in claim 1 wherein each of the terminals is operable in two antenna modes, and in accordance with the at least one BIA code with L equal to 1, the one or more base stations transmits a sum of 2 symbol streams of 2 different users during all but 2 of the K+1 transmission slots.

6. The wireless communication system defined in claim 1 wherein each time slot comprises a time-frequency slot in an OFDM transmission or a block of time-frequency slots in the OFDM plane.

7. The wireless communication system defined in claim 1 wherein each transmitter in a base-station generates a stream based on data intended for one or more of the terminals without using channel state information and in which only one antenna is active at each terminal during a given transmission slot.

8. The wireless communication system defined in claim 1 wherein the one or more base stations employ a plurality of BIA codes that span several coherence times.

9. The wireless communication system defined in claim 1 wherein only one antenna is active at each terminal in the plurality of terminals during a given transmission slot.

10. The wireless communication system defined in claim 1 wherein each of the M distinct transmissions corresponding to each of the L symbols for user k have a different power level.

11. The wireless communication system defined in claim 1 wherein the power level per slot is constant and shared among symbols transmitted in a slot.

12. A method for communicating in a wireless communication system having a plurality of terminals and one or more base stations, wherein each terminal has a single radio frequency (RF) chain that is operable to switch among at least M antenna modes, and further wherein each of the one or more base stations has one or more transmit antennas and being operable to communicate with one or more of the terminals using a blind interference alignment (BIA) scheme, the method comprising:
performing downlink transmission with the one or more base stations to transmit wireless signals to the plurality of receivers with a transmitter array using a blind interference alignment (BIA) scheme while the plurality of receivers shift between the plurality of antenna modes in a predetermined manner, including using at least one code BIA code serving K terminals from the transmitter array over L(M+K−1) slots for some L>0, wherein at least one of the one or more base stations transmits L symbols to each user k, and where the L symbols for any given terminal are transmitted in M distinct slots each over L(M+D−1) consecutive slots for some integer D smaller than K.

13. The method defined in claim 12 wherein each of the L symbols is R-dimensional, where R is an integer, and wherein L is equal to M−1^{(K-1)} and R equals M.

14. The method defined in claim 12 wherein the L symbols are transmitted M times each in ML slots from slot (k−1)L+1 to slot (k−1)L+ML.

15. The method defined in claim 12 wherein the BIA scheme uses at least one code BIA code for serving K users over K+1 transmission slots, with a predetermined delay parameter D, each user terminal being operable in two antenna modes
wherein if K is even and equals 2K′ for an integer K′, then for the given D, satisfying 0<D<K′:
for users with index k between 1 and K′, the symbol for user k is placed in slots k and min(K′+1, k−D+1);
for users with index k greater than K′, the symbol for user k is placed in slots k+1 and max(K′, k−D+1);
wherein if K is odd and equals 1+2K′ for the integer K′, then for a given D, satisfying 0<D<K′:
for users with index k between 1 and K′, the symbol for user k is placed in slots k and min(k+D, K′+1);
for users with index k greater than K′+1, the symbol for user k is placed at slots k+1 and max(k^{t}+2, k−D+1);
for the user with index k equal to K′+1, the symbol for user k is placed at slots K′+1 and K′+2.

16. The method defined in claim 12 wherein each of the receivers is operable in two antenna modes, and in accordance with the at least one BIA code with L equal to 1, the one or more base stations transmits a sum of 2 symbol streams of 2 different users during all but 2 of the K+1 transmission slots.

17. The method defined in claim 12 wherein each transmission slot comprises a time-frequency slot in an OFDM transmission or a block of time-frequency slots in an OFDM plane.

18. The method defined in claim 12 further comprising each transmitter in a base-station generating a stream based on data intended for one or more of the receivers without using channel state information and in which only one antenna is active at each receiver during a given transmission slot.

19. The method defined in claim 12 further comprising employing, by the one or more base stations, a plurality of BIA codes that span several coherence times.

20. The method defined in claim 12 wherein only one antenna is active at each receiver in the plurality of terminals during a given transmission slot.

21. The method defined in claim 12 wherein each of the M distinct transmissions corresponding to each of the L symbols for user k have a different power level.

22. The method defined in claim 12 wherein the power level per slot is constant and shared among symbols transmitted in a slot.

23. A base station to perform downlink transmissions to a plurality of terminals in a wireless communication system, the base station comprising:
one or more transmitters;
one or more transmit antennas coupled to the one or more transmitters, the one or more transmitters and transmit antennas operating together to communicate with one or more of the terminals using a multi-user MIMO (MU-MIMO)-based blind interference alignment (BIA) scheme that uses at least one code BIA code serving K terminals from the one or more transmitters over L(M+K−1) slots for some L>0, wherein at least one of the one or more transmitters and transmit antennas in cooperation with transmitters and transmit antennas of one or more other base stations transmits L symbols to each user k, and where the L symbols for any given terminal are transmitted in M distinct slots each over L(M+D−1) consecutive slots for some integer D smaller than K.
